(19) United States
(12) Patent Application Publication
(10) Pub. No.: US 2013/0260732 A1
(43) Pub. Date: Oct. 3, 2013

(54) TECHNIQUES FOR POWER SAVING FOR MULTIMODE WIRELESS DEVICE USING WIRELESS COMMUNICATION NETWORK DEPLOYMENT INFORMATION

(71) Applicant: Satpreet SINGH, Plano, TX (US)

(72) Inventor: Satpreet SINGH, Plano, TX (US)

(73) Assignee: SAMSUNG ELECTRONICS CO. LTD., Suwon-si (KR)

(21) Appl. No.: 13/438,244

(22) Filed: Apr. 3, 2012

(51) Int. Cl. H04W 88/06; H04W 4/02

(52) U.S. Cl. 455/418; 455/552.1

(57) ABSTRACT

A method for operating a multimode wireless device, and the multimode wireless device thereof, are provided. The method includes determining whether the multimode wireless device is located at a location, or within a threshold distance of the location, in which the multimode wireless device can be serviced by a first wireless communication network based on a determined location and wireless communication network deployment information, when it is determined that the multimode wireless device is located at the location, or within the threshold distance of the location, controlling a first communication module corresponding to the first wireless communication network to be in an active state, and when it is determined that the multimode wireless device is not located at the location, or within the threshold distance of the location, controlling the first communication module to be in an inactive state.

### BACKGROUND OF THE INVENTION

1. Field of the Invention

Aspects of the present invention relate to power saving for a multimode wireless device. More particularly, aspects of the present invention relate to techniques for power saving for a multimode wireless device using wireless communication network deployment information.

2. Description of the Related Art

The deployment of a next generation wireless communication network typically occurs over a lengthy period of time. During that lengthy deployment, the next generation wireless communication network is deployed in fewer areas than a current generation wireless communication network. Accordingly, it is advantageous for a wireless device that has the ability to communicate with the next generation wireless communication network, to also have the ability to communicate with the current generation wireless communication network in order to receive service in the areas where the next generation wireless communication network is not yet deployed. Such a wireless device is referred to as a multimode wireless device. The multimode wireless device may include a plurality of communication modules, each communication module for supporting communication with a respective wireless communication network. Examples of various wireless communication networks include Long Term Evolution (LTE), 1x Radio Transmission Technology (1x RTT), 1x EVolution Data Only (1xEVDO), evolved High Rate Packet Data (eHRPD), etc.

However, power consumption is an issue for the multimode wireless device. This is because the plurality of communication modules of the multimode wireless device are each operational regardless of whether the multimode wireless device is at a location serviced by a corresponding wireless communication network. Thus, power will unnecessarily be consumed by a communication module of the multimode wireless device, when the multimode wireless device is not at a location serviced by the corresponding wireless communication network. Accordingly, there is a need for a technique to mitigate the above identified waste of power.

The above information is presented as background information only to assist with an understanding of the present disclosure. No determination has been made, and no assertion is made, as to whether any of the above might be applicable as Prior Art with regard to the present invention.

### SUMMARY OF THE INVENTION

An aspect of the present invention is to address at least the above-mentioned problems and/or disadvantages and to provide at least the advantages described below. Accordingly, an aspect of the present invention is to provide techniques for power saving for a multimode wireless device.

Another aspect of the present invention is to provide techniques for power saving for a multimode wireless device using wireless communication network deployment information.

In accordance with an aspect of the present invention, a method for operating a multimode wireless device in a communication system including a plurality of wireless communication networks, wherein the multimode wireless device includes a plurality of communication modules, each communication module for supporting communication with a respective one of the plurality of wireless communication networks, is provided. The method includes receiving wireless communication network deployment information, determining a location of the multimode wireless device, determining whether the multimode wireless device is located at a location, or within a threshold distance of the location, in which the multimode wireless device can be serviced by a first wireless communication network among the plurality of wireless communication networks based on the determined location and the wireless communication network deployment information, when it is determined that the multimode wireless device is located at the location, or within the threshold distance of the location, in which the multimode wireless device can be serviced by the first wireless communication network, controlling a first communication module corresponding to the first wireless communication network to be in an active state, and when it is determined that the multimode wireless device is not located at the location, or within the threshold distance of the location, in which the multimode wireless device can be serviced by the first wireless communication network, controlling the first communication module to be in an inactive state.

In accordance with yet another aspect of the present invention, a multimode wireless device for use in a communication system including a plurality of wireless communication networks is provided. The multimode wireless device includes a plurality of communication modules, each communication module for supporting communication with a respective one of the plurality of wireless communication networks, a location determination module for determining a location of the multimode wireless device, a memory for storing wireless communication network deployment information, and a controller for determining whether the multimode wireless device is located at a location, or within a threshold distance of the location, in which the multimode wireless device can be serviced by a first wireless communication network among the plurality of wireless communication networks based on the location determined by the location determination module and the wireless communication network deployment information stored in the memory, for controlling a first communication module corresponding to the first wireless communication network to be in an active state when it is determined that the multimode wireless device is located at the location, or within the threshold distance of the location, in which the multimode wireless device can be serviced by the first wireless communication network, and for controlling the first communication module to be in an inactive state when it is determined that the multimode wireless device is not located at the location, or within the threshold distance of the location, in which the multimode wireless device can be serviced by the first wireless communication network.

In accordance with still another aspect of the present invention, a method for provisioning wireless communication network deployment information to a multimode wireless device in a communication system including a plurality of wireless communication networks is provided. The method includes determining whether to provision the multimode wireless device, and when it is determined to provision the multimode wireless device, transmitting wireless communication network deployment information to the multimode wireless device. The wireless communication network deployment information at least one of defines boundaries of one or more service coverage areas of a first wireless communication network, identifies one or more locations of one or more corresponding base stations of the first wireless communication network, defines boundaries of the one or more service coverage areas of the first wireless communication network with reference to one or more locations or identifying information of one or more corresponding base stations of a second wireless communication network of the plurality of wireless communication networks, and identifies locations of one or more base stations of the first wireless communication network with reference to one or more locations or identifying information of the one or more corresponding base stations of the second wireless communication network.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a conceptual diagram illustrating a communication system including a plurality of wireless communication networks according to an exemplary embodiment of the present invention;

FIG. 2 is a block diagram illustrating a configuration of a multimode wireless device according to an exemplary embodiment of the present invention;

FIG. 3 is a flowchart illustrating a method for provisioning wireless communication network deployment information to a multimode wireless device according to an exemplary embodiment of the present invention;

FIG. 4 is a flowchart illustrating a method for operating a multimode wireless device to perform a power saving technique according to an exemplary embodiment of the present invention; and

FIG. 5 is a conceptual diagram illustrating a power saving technique for a multimode wireless device using wireless communication network deployment information according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of term “substantially” is equally applicable when used in a negative connotation to refer to the complete or near complete lack of an action, characteristic, property, state, structure, item, or result.

As used herein, the term “about” is used to provide flexibility to a numerical range endpoint by providing that a given value may be “a little above” or “a little below” the endpoint.

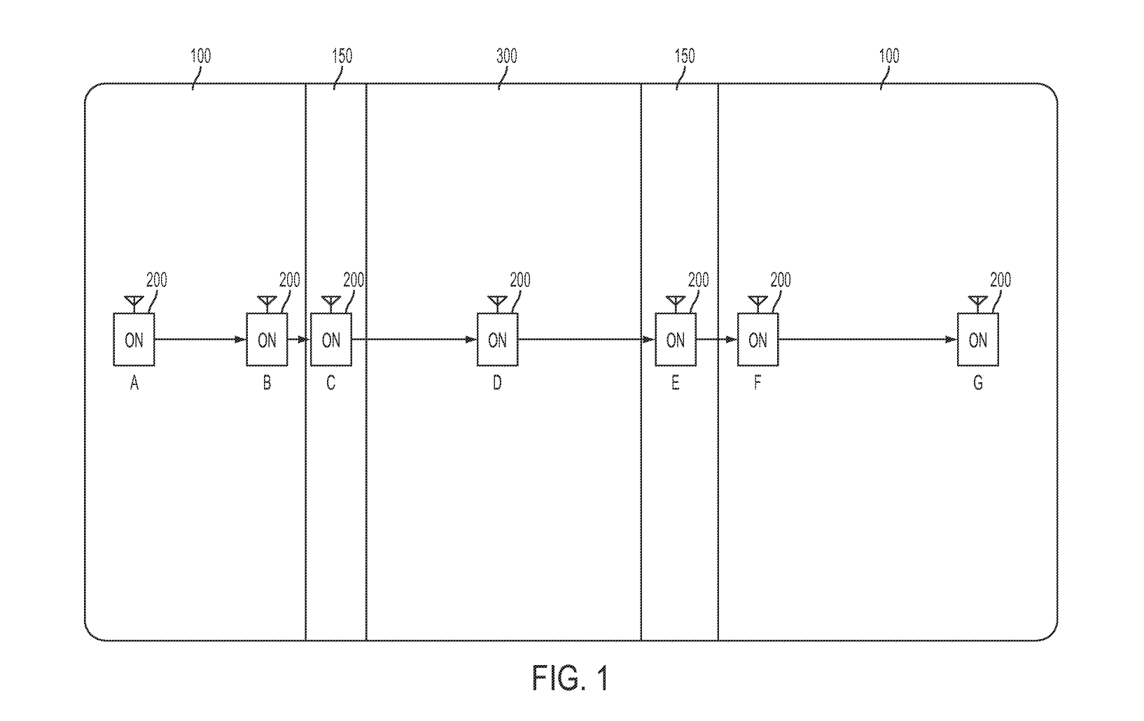

FIGS. 1 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Exemplary embodiments of the present invention described below relate to techniques for power saving for a multimode wireless device. More particularly, exemplary embodiments of the present invention are applicable techniques for power saving for a multimode wireless device using wireless communication network deployment information.

While certain aspects of the techniques for power saving for a multimode wireless device may be described below in the context of at least one of a Long Term Evolution (LTE), 1x Radio Transmission Technology (1x RTT), 1x EVolution Data Only (1xEVDO), and evolved High Rate Packet Data (eHRPD) wireless communication network, those aspects of the present invention are not limited thereto and are similarly applicable to other networks, such as Global System for Mobile Communications (GSM), Universal Mobile Telecommunications System (UMTS), CDMA, Wireless Fidelity (WiFi), Worldwide Interoperability for Microwave Access (WiMAX), LTE-Advanced (LTE-A), etc.

It should be understood that the following description may refer to terms utilized in various standards merely for simplicity in explanation. For example, the following description may refer to terms utilized in at least one of the 3G Partnership Project (3GPP) standards, such as the 1x RTT and LTE standards. However, the description herein should not be interpreted as being limited to such standards. Independent of the mechanism used for power saving for a multimode wireless device, it is advantageous for that ability to conform to a standardized mechanism.

The description of the exemplary embodiments of the present invention may refer to the term “wireless device.” It is to be understood that the term “wireless device” is merely a generic term and that the invention is equally applicable to any type of device, such as a Personal Computer (PC), laptop computer, a mobile phone, a palm sized PC, a netbook, a Personal Digital Assistant (PDA), a Hand-Held PC (HPC), a smart phone, a wireless Local Area Network (LAN) terminal, a wireless data card, a Portable Multimedia Player (PMP), Moving Picture Experts Group (MPEG) audio layer 3 (MP3) player, a Digital broadcast receiver, and their equivalent devices supporting radio communication. Accordingly, use of the term “wireless device” should not limit application of the present inventive concepts to any certain type of apparatus or device.

In addition, the description of the exemplary embodiments of the present invention may refer to the term “multimode wireless device,” which denotes a wireless device that supports at least two different wireless communication networks based on Time Division Multiple Access (TDMA), Frequency Division Multiple Access (FDMA), Code Division Multiple Access (CDMA), Orthogonal Frequency Division Multiple Access (OFDMA), and the like.

A communication system including a plurality of wireless communication networks and a handover of multimode wireless device 200 between the plurality of wireless communication networks is described below with reference to FIG. 1.

FIG. 1 is a conceptual diagram illustrating a communication system including a plurality of wireless communication networks according to an exemplary embodiment of the present invention.

Referring to FIG. 1, the mobile communication system includes a first wireless communication network 100, a second wireless communication network 300, and a multimode wireless device 200. In this exemplary embodiment, the first wireless communication network 100 is exemplified as a 3^{rd} Generation (3G) wireless communication network such as Universal Mobile Telecommunications System (UMTS), Wideband Code Division Multiple Access (WCDMA) system and the like, and the second wireless communication network 300 is exemplified as a 4^{th} Generation (4G) wireless communication network such as an LTE system, an LTE-A system, and the like. However, the present invention is not limited to above identified communication systems and can be applied to any two different communication systems.

Although not shown, the second wireless communication network 300 may overlap the first wireless communication network 100. Herein it is assumed that the second wireless communication network 300 is preferred over the first wireless communication network 100. That is, it is assumed that when the multimode wireless device 200 is able to communicate with both the first wireless communication network 100 and the second wireless communication network 300, the multimode wireless device 200 will prefer to use the second wireless communication network 300.

The multimode wireless device 200 is exemplified as a dual band multimode wireless device supporting communication with the 3G and 4G wireless communication networks 100 and 300. However, the present invention is not limited to a dual band multimode wireless device and can be applied to multimode wireless device supporting communications with three or more different communication systems. The multimode wireless device 200 may be provided with two communication modules for separately processing communications with the first and second wireless communication networks 100 and 300.

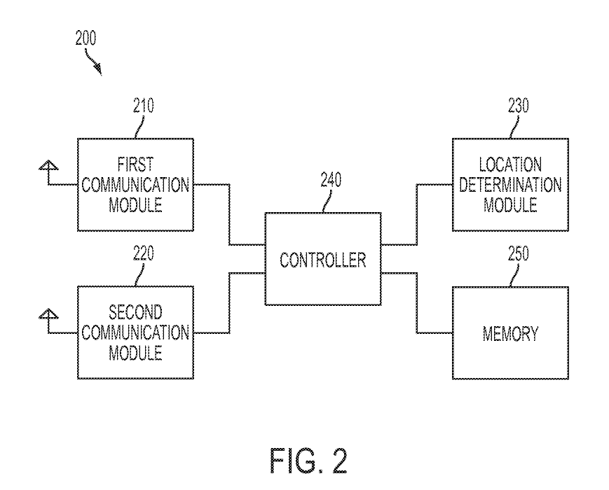

In FIG. 1, the term “ON” located in the multimode wireless device 200 refers to a second communication module 220 (see FIG. 2) of the multimode wireless device 200 for supporting communication with the second wireless communication network 300 being in an active state.

When the first wireless communication network 100 is the 3G wireless communication network, the first wireless communication network 100 may include a Node B (NB) for providing radio access service to the multimode wireless device 200, a Radio Wireless communication network Controller (RNC) for controlling the Node-B, a Serving general packet radio service (GPRS) Support Node (SGSN) connected to the RNC for switching packet switched communications to and from the multimode wireless device 200, and a Mobile Switching Center (MSC) connected to the RNC for switching circuit switch communications to and from the multimode wireless device 200.

When the second wireless communication network 300 is a 4G wireless communication network, the second wireless communication network 300 may include a evolved Node B (eNB) for providing radio access service to the multimode wireless device 200, a Mobility Management Entity/Serving GateWay (MME/SGW) connected to the eNB for switching packet switched communications to and from the multimode wireless device 200.

At locations A and B, the multimode wireless device 200 is associated with and served by the first wireless communication network 100. Here, the multimode wireless device 200 measures signal strength on radio channels associated with the second wireless communication network 300 periodically. When the multimode wireless device 200 determines that the received signal strength of the first wireless communication network 200 is greater than a preset threshold value upon the wireless device 200 moving into an overlapping area 150 of the first and second wireless communication networks 100 and 300 at location C, a handover of the multimode wireless device 200 to the second wireless communication network 300 is initiated based on a handover procedure for handing off from the first wireless communication network 100 to the second wireless communication network 300. That is, the handover can be initiated by the multimode wireless device 200 or the first wireless communication network 100. If the handover is initiated, the multimode wireless device 200 may establish a connection with the second wireless communication network 300 before breaking the connection with the first wireless communication network 100 for maintaining seamless service.

At location D, the multimode wireless device 200 is associated with and served by the second wireless communication network 300. Here, the multimode wireless device 200 continues to measure signal strength on radio channels associated with the second wireless communication network 300. When the multimode wireless device 200 determines that the received signal strength of the second wireless communication network 300 is less than a preset threshold value upon the wireless device 200 moving out of the second wireless communication network 300 and into an overlapping area 150 of the first and second wireless communication networks 100 and 300 at location E, a handover of the multimode wireless device 200 to the first wireless communication network 300 is initiated based on a handover procedure for handing off from the second wireless communication network 300 to the first wireless communication network 100. That is, the handover can be initiated by the multimode wireless device 200 or the second wireless communication network 300. If the handover is initiated, the multimode wireless device 200 may establish a connection with the first wireless communication network 100 before breaking the connection with the second wireless communication network 300 for maintaining seamless service.

Thereafter, at locations F and G the multimode wireless device 200 is associated with and served by the first wireless communication network 100. Here, the multimode wireless device 200 measures signal strength on radio channels associated with the second wireless communication network 300 periodically.

The measuring of the signal strength on radio channels associated the second wireless communication network 300 consumes power of the multimode wireless device 200. Thus, the measuring of the signal strength on radio channels associated the second wireless communication network 300 at locations A and G, which are far away from, and in which there is a very low probability of connecting to, the second wireless communication network 300 is a waste of the power of multimode wireless device 200.

A configuration of a multimode wireless device 200 is described below with reference to FIG. 2.

FIG. 2 is a block diagram illustrating a configuration of a multimode wireless device according to an exemplary embodiment of the present invention.

Referring to FIG. 2, the multimode wireless device 200 includes a first communication module 210 for supporting communication with the first wireless communication network 100, a second communication module 220 for supporting communication with the second wireless communication network 300, a location determination module 230, a controller 240 for controlling operations of the multimode wireless device 200, and a memory 250. The multimode wireless device 200 may also include other components not shown here for purposes of convenience, such as an input unit, a display unit, etc. Similarly, the functionality of two or more of the above components may be integrated into a single component. Also, various components may be implemented in hardware, or as a combination of hardware software according to design.

The first communication module 210 supports communication with the first wireless communication network 100. The first communication module 210 may include a first Radio Frequency (RF) unit for processing the reception and transmission frequencies, and a first modem for processing the signals received from and to be transmitted to the first wireless communication network 100 according to radio communication protocols specified between the multimode wireless device 200 and the first wireless communication network 100. The first communication module 210 may be in one of an active state and inactive state. In the active state, the first communication module 210 is supplied with power and is operational for communication with the first wireless communication network 100. In the inactive state, the first communication module 210 is either not supplied with power or is otherwise in power conversation state, and is not operational for communication with the first wireless communication network 100.

The second communication module 220 supports communication with the second wireless communication network 300. The second communication module 220 may include a second RF unit for processing the reception and transmission frequencies, and a second modem for processing the signals received from and to be transmitted to the second wireless communication network 300 according to radio communication protocols specified between the multimode wireless device 200 and the second wireless communication network 220. The second communication module 220 may be in one of an active state and inactive state. In the active state, the second communication module 220 is supplied with power and is operational for communication with the second wireless communication network 300. In the inactive state, the second communication module 220 is either not supplied with power or is otherwise in a power conversation state, and is not operational for communication with the second wireless communication network 300.

Although not depicted in FIG. 2, the multimode wireless device 200 may include additional communication modules. Also, while a dedicated antenna is depicted in FIG. 2 as being associated with each of the first communication module 210 and the second communication module 220, the multimode wireless device 200 may use a common antenna for the first communication module 210 and the second communication module 220. When a common antenna is used for the first communication module 210 and the second communication module 220, each of the first communication module 210 and the second communication module 220 may include a duplexer for separating reception and transmission frequencies of the respective frequency band.

The location determination module 230 determines the location of the multimode wireless device 200. The location determination module 230 may be implemented with a Global Positioning System (GPS) module. The multimode wireless device 200 may employ a GPS module by itself in order to determine its current location. Alternatively, the multimode wireless device 200 can detect its current location by using network based Assisted-GPS (A-GPS). The location determination module 230 may also determine a speed and/or trajectory of the multimode wireless device 200.

Moreover, the multimode wireless device 200 may alternatively or additionally employ other location determination technologies, such as the triangulation of RF signals, a correspondence of a coverage area to a known location, a transmission and/or reception range, or some combination thereof, that may be implemented to determine the location of the multimode wireless device 200. When other location determination technologies are alternatively employed the location determination module 230 may be omitted.

The controller 240 controls operations of the multimode wireless device 200, including its constituent components and the signal flow there between. More particularly, the controller 240 may control the operations of the first communication module 210 and the first communication module 210 based on a location determined by the location determination module 230 and wireless communication network deployment information. For example, the controller 240 may control the first communication module 210 to be in one of the active state and the inactive state. Likewise, the controller 240 may control the second communication module 220 to be in one of the active state and the inactive state. The wireless communication network deployment information may be stored in the memory 250.

The wireless communication network deployment information is information used by the controller 240 to determine one or more locations (e.g., latitude and longitude) where the first wireless communication network 100 and/or the second wireless communication network 300 provide service. The wireless communication network deployment information may define the boundaries of one or more of the service coverage areas of the first wireless communication network 100 and/or the second wireless communication network 300. The wireless communication network deployment information may identify one or more locations of one or more corresponding base stations of the first wireless communication network 100 and/or the second wireless communication network 300. In addition, the wireless communication network deployment information may define boundaries of the one or more service coverage areas of one of the first wireless communication network 100 and the second wireless communication network 300 with reference to one or more locations or identifying information of one or more corresponding base stations of the other one of the first wireless communication network 100 and the second wireless communication network 300. Also, the wireless communication network deployment information may identify one or more locations of the corresponding base stations of the first wireless communication network 100 and/or the second wireless communication network 300 with reference to one or more locations or identifying information of the one or more corresponding base stations of the other one of the first wireless communication network 100 and the second wireless communication network 300. The wireless communication network deployment information may also include wireless communication network deployment information for one or more wireless communication networks to which the multimode wireless device 200 may roam from the respective first wireless communication network 100 and the second wireless communication network 300.

The wireless communication network deployment information may be inclusive of information regarding areas within a threshold distance of the one or more locations where the first wireless communication network 100 and/or the second wireless communication network 300 provide service. Alternatively, the controller 240 may determine whether the location determined by the location determination module 230 is within the threshold distance of the one or more locations where the first wireless communication network 100 and/or the second wireless communication network 300 provide service as determined from the wireless communication network deployment information. Herein, the threshold distance may be determined in a fixed or adaptive manner. For example, the threshold distance may be a predefined distance. In another example, the threshold distance may depend on at least one of the location, speed, and trajectory of the multimode wireless device 200.

In addition, the controller 240 may control the operations of the first communication module 210 and the second communication module 220 so as to receive the wireless communication network deployment and store the wireless communication network deployment in the memory 250. In addition, the controller 240 may perform or control to have performed other operations including any other operation described herein as being explicitly or implicitly performed by multimode wireless device 200.

The memory 250 may be implemented with volatile memory (such as Random Access Memory (RAM)), non-volatile memory (such as Read Only Memory (ROM), flash memory, etc.), or some combination of thereof. The memory 250 includes a program area and a data area. The program area may store an Operating System (OS) used for booting the multimode wireless device 200, application programs used by the controller 240 to perform or control to have performed any operation described herein as being explicitly or implicitly performed by multimode wireless device 200, and application programs for other optional functions, such as a camera function, an audio playback function, an image or moving image playback function, and the like.

The data area of the memory 250 stores data generated as the multimode wireless device 200 is operated. The data includes user data and information corresponding to the user data, where the user data is related to a variety of optional functions, for example, images or moving images captured by a camera of the portable terminal, phone book data, audio data, contents, and the like. More particularly, the data area may store the wireless communication network deployment information.

Hereinafter, the operations of the above structured multimode wireless device 200 are described in association with the techniques for power saving for the multimode wireless device 200 accordingly to exemplary embodiments of the present invention. However, the present invention is not limited to the above structured multimode wireless device 200, and can be implemented with changes in the structure and operations thereof.

The wireless communication network deployment information used by the controller 240 to control the operations of the first communication module 210 and the first communication module 210 based on the location determined by the location determination module 230 may be received by the multimode wireless device 200 through provisioning of the multimode wireless device 200 and/or wireless communication network initiated parameters updating. For example, the data may be received though Over-The-Air (OTA) programming such as Over-The-Air Service Provisioning (OTASP), Over-The-Air Provisioning (OTAP), Over-The-Air Parameter Administration (OTAPA), or the provisioning of the multimode wireless device 200 with the settings with which to access services such as Wireless Application Protocol (WAP) or Multimedia Messaging Service (MMS). However, the wireless communication network deployment information used by the controller 240 to control the operations of the first communication module 210 and the first communication module 210 based on the location determined by the location determination module 230 may be provided to the multimode wireless device 200 through any other mechanism. For example, the wireless communication network deployment information may be downloaded by a user of the multimode wireless device 200 and stored thereon.

When the multimode wireless device 200 is provisioned over the air, the wireless communication network deployment information, along with other information, such as a preferred roaming list, are provided to the multimode wireless device 200. The provisioning may be performed by one of the first wireless communication network 100 and the second wireless communication network 300 for wireless communication network deployment information for both the first wireless communication network 100 and the second wireless communication network 300. Alternatively, one or both of the first wireless communication network 100 and the second wireless communication network 300 may provide the wireless communication network deployment information for the respective one or both of the first wireless communication network 100 and the second wireless communication network 300. The wireless communication network deployment information may be periodically updated based on a predefined time period. Alternatively, the wireless communication network deployment information may be updated based on a triggering event or at the discretion of a wireless communication network operator.

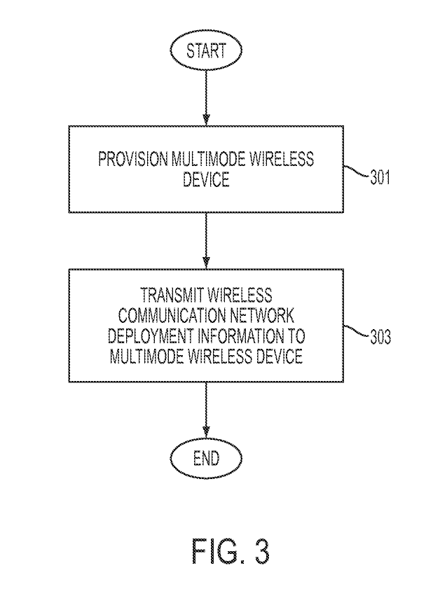

The provisioning of wireless communication network deployment information to the multimode wireless device 200 will be described below with reference to FIG. 3.

FIG. 3 is a flowchart illustrating a method for provisioning wireless communication network deployment information to a multimode wireless device according to an exemplary embodiment of the present invention.

Referring to FIG. 3, in step 301, it is determined whether to provision the multimode wireless device 200. The determination may be made by at least one of the first wireless communication network 100, the second wireless communication network 300, and an entity independent of the first wireless communication network 100 and the second wireless communication network 300. In step 303, the wireless communication network deployment information is transmitted to the multimode wireless device 200. The wireless communication network deployment information may be transmitted to the multimode wireless device 200 through at least one of the first wireless communication network 100 and the second wireless communication network 300. Thereafter, the multimode wireless device 200 may store the wireless communication network deployment information and use it when performing a power saving technique for the multimode wireless device 200 according to an exemplary embodiment of the present invention.

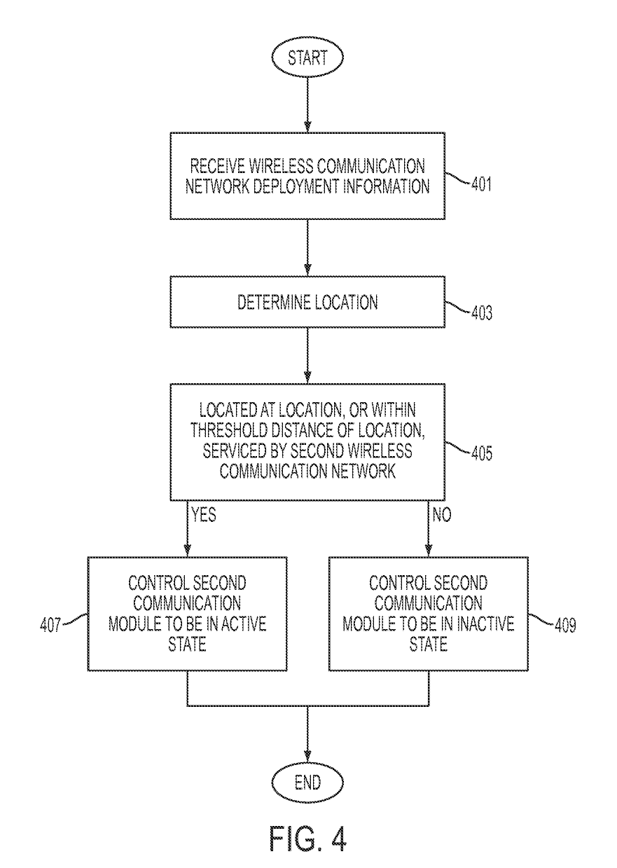

The method for operating the multimode wireless device 200 to perform the power saving technique is described below with reference to FIG. 4.

FIG. 4 is a flowchart illustrating a method for operating a multimode wireless device to perform a power saving technique according to an exemplary embodiment of the present invention.

Referring to FIG. 4, in step 401, the multimode wireless device 200 receives the wireless communication network deployment information. The multimode wireless device 200 may receive the wireless communication network deployment information according to the method described above with respect to FIG. 3. That is, the multimode wireless device 200 may receive the wireless communication network deployment information form at least one of the first wireless communication network 100 and the second wireless communication network 300.

In step 403, the multimode wireless device 200 determines its location. The multimode wireless device 200 may determine its location using the location determination module 230. The wireless device 200 may determine its location either periodically or upon detecting a triggering event.

In step 405, the multimode wireless device 200 determines whether it is located at a location, or within a threshold distance of the location, in which it can be serviced by the second wireless communication network 300 based on the determined location and the wireless communication network deployment information. Herein, when the wireless communication network deployment information is inclusive of the area within a threshold distance of the location in which the multimode wireless device 200 can be serviced by the second wireless communication network 300, the multimode wireless device 200 may not have to determine the area within a threshold distance of the location in which the multimode wireless device 200 can be serviced by the second wireless communication network 300. However, when the wireless communication network deployment information is not inclusive of the area within the threshold distance of the location in which the multimode wireless device 200 can be serviced by the second wireless communication network 300, the multimode wireless device 200 may determine whether the multimode wireless device 200 is within the threshold distance of the location in which the multimode wireless device 200 can be serviced by the second wireless communication network 300. The threshold distance may be determined in a fixed or adaptive manner. For example, the threshold distance may be a predefined distance. In another example, the threshold distance may depend on at least one of the location, speed, and trajectory of the multimode wireless device 200.

When it is determined that the multimode wireless device 200 is located at the location, or within the threshold distance of the location, in which it can be serviced by the second wireless communication network 300, in step 407, the second communication module 220 may be controlled to be in an active state.

When it is determined that the multimode wireless device 200 is not located at the location, or within the threshold distance of the location, in which it can be serviced by the second wireless communication network 300, in step 409, the second communication module 220 may be controlled to be in an inactive state.

After steps 407 and 409, an iteration of the power saving technique is complete. However, a next iteration of the power saving technique may begin. Here, step 401 may be omitted and the next iteration of the power saving technique may begin at step 403. In addition, the next iteration of the power saving technique may automatically begin at step 403. Alternatively, after steps 407 and 409, it may be determined whether new wireless communication network deployment information is to be received. If the new wireless communication network deployment information is to be received, the next iteration of the power saving technique may begin at step 401. Otherwise, if the new wireless communication network deployment information is to be received, the next iteration of the power saving technique may begin at step 403.

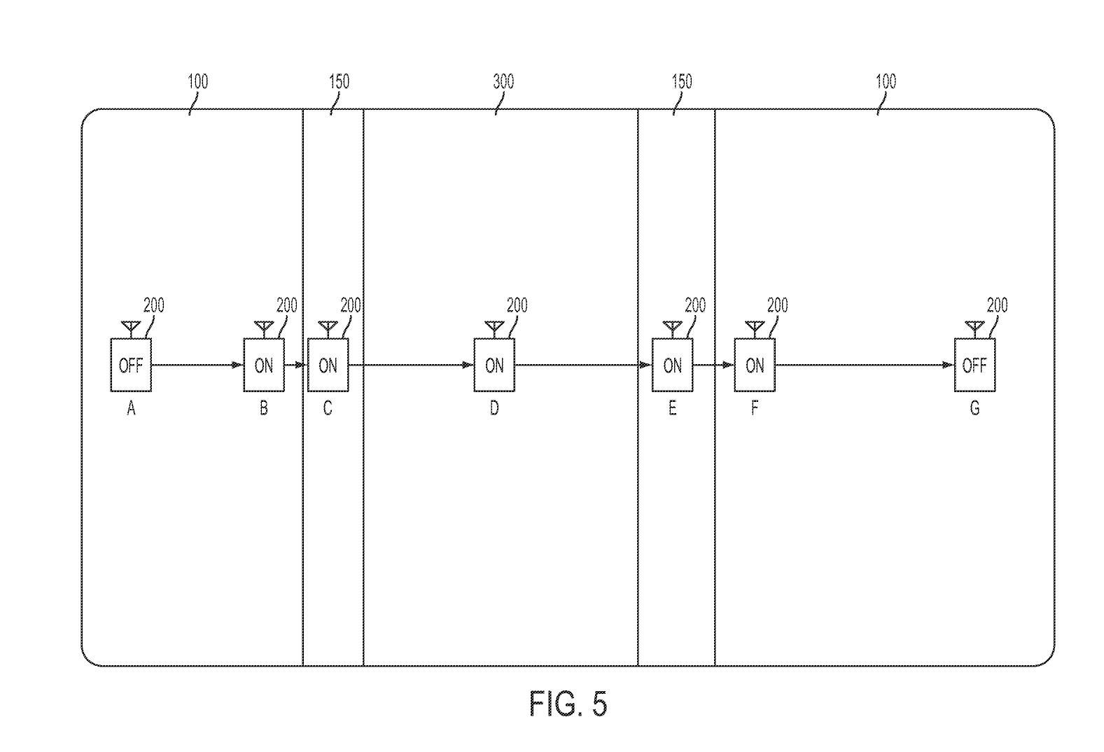

An example of the power saving technique for the multimode wireless device 200 using the wireless communication network deployment information is described below with reference to FIG. 5.

FIG. 5 is a conceptual diagram illustrating a power saving technique for a multimode wireless device using wireless communication network deployment information according to an exemplary embodiment of the present invention.

The environment and the handoff operations of FIG. 5 are substantially the same as those described above with respect to FIG. 1, and thus descriptions thereof with respect to FIG. 5 are omitted herein for brevity. In FIG. 5, the term “ON” located in the multimode wireless device 200 refers to the second communication module 220 of the multimode wireless device 200 for supporting communication with the second wireless communication network 300 being in an active state. Also, the term “OFF” located in the multimode wireless device 200 refers to the second communication module 220 of the multimode wireless device 200 for supporting communication with the second wireless communication network 300 being in an inactive state.

With reference to FIG. 5, at location A, the multimode wireless device 200, while being associated with and served by the first wireless communication network 100, determines that it is not at a location, or within a threshold distance of the location, in which it can be serviced by the second wireless communication network 300 based on its determined location and the wireless communication network deployment information. Thus, the multimode wireless device 200 controls the second communication module 220 to be in the inactive state, thereby saving power.

At location B, the multimode wireless device 200, while being associated with and served by the first wireless communication network 100, determines that it is within a threshold distance to the location in which it can be serviced by the second wireless communication network 300 based on its determined location and the wireless communication network deployment information. Thus, the multimode wireless device 200 controls the second communication module 220 to be in the active state, thereby preparing the multimode wireless device 200 to enter the service coverage area of the second wireless communication network 300.

At locations C, D, and E, the multimode wireless device 200 determines that it is at the location in which it can be serviced by the second wireless communication network 300 based on its determined location and the wireless communication network deployment information. Thus, the multimode wireless device 200 controls the second communication module 220 to remain in the active state. Also, at location C, the multimode wireless device 200 performs handover from the first wireless communication network 100 to the second wireless communication network 300 as described above with respect to FIG. 1. At location D, the multimode wireless device 200 remains associated with and served by the second wireless communication network 300 as described above with respect to FIG. 1. At location E, the multimode wireless device 200 performs handover from the second wireless communication network 300 to the first wireless communication network 100 as described above with respect to FIG. 1.

At location F, the multimode wireless device 200, while being associated with and served by the first wireless communication network 100, determines that it within the threshold distance to the location in which it can be serviced by the second wireless communication network 300 based on its determined location and the wireless communication network deployment information. Thus, the multimode wireless device 200 controls the second communication module 220 to remain in the active state, thereby enabling the multimode wireless device 200 to be prepared in case it reenters the service coverage area of the second wireless communication network 300.

At location G, the multimode wireless device 200, while being associated with and served by the first wireless communication network 100, determines that it is not at the location, or within a threshold distance of the location, in which it can be serviced by the second wireless communication network 300 based on its determined location and the wireless communication network deployment information. Thus, the multimode wireless device 200 controls the second communication module 220 to be in the inactive state, thereby saving power.

Although it has been described above that the multimode wireless device 200 controls the second communication module 220 to be in the active state when it is within a threshold distance from a location in which it can be serviced by the second wireless communication network 300 (i.e., locations B and F), the multimode wireless device 200 may alternatively control the second communication module 220 to be in the active state only when it is at a location in which it can be serviced by the second wireless communication network 300 (i.e., locations C, D, and E).

Although it has been described above that the multimode wireless device 200 controls one communication module to be in the active state or inactive state based on the location of the multimode wireless device 200 and wireless communication network deployment information, two or more communication modules corresponding to respective wireless communication networks may be controlled.

At this point it should be noted that the exemplary embodiments of the present disclosure as described above typically involve the processing of input data and the generation of output data to some extent. This input data processing and output data generation may be implemented in hardware, or software in combination with hardware. For example, specific electronic components may be employed in a mobile device or similar or related circuitry for implementing the functions associated with the exemplary embodiments of the present invention as described above. Alternatively, one or more processors operating in accordance with stored instructions (i.e., code) may implement the functions associated with the exemplary embodiments of the present invention as described above. If such is the case, it is within the scope of the present disclosure that such instructions may be stored on one or more non-transitory processor readable mediums. Examples of the non-transitory processor readable mediums include ROM, RAM, Compact Disc (CD)-ROMs, magnetic tapes, floppy disks, and optical data storage devices. The non-transitory processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a multimode wireless device in a communication system including a plurality of wireless communication networks, wherein the multimode wireless device includes a plurality of communication modules, each communication module for supporting communication with a respective one of the plurality of wireless communication networks, the method comprising:
receiving wireless communication network deployment information;
determining a location of the multimode wireless device;
determining whether the multimode wireless device is located at a location, or within a threshold distance of the location, in which the multimode wireless device can be serviced by a first wireless communication network among the plurality of wireless communication networks based on the determined location and the wireless communication network deployment information;
when it is determined that the multimode wireless device is located at the location, or within the threshold distance of the location, in which the multimode wireless device can be serviced by the first wireless communication network, controlling a first communication module corresponding to the first wireless communication network to be in an active state; and
when it is determined that the multimode wireless device is not located at the location, or within the threshold distance of the location, in which the multimode wireless device can be serviced by the first wireless communication network, controlling the first communication module to be in an inactive state.

2. The method of claim 1, wherein the wireless communication network deployment information is received from at least one of the plurality of wireless communication networks and stored in the multimode wireless device.

3. The method of claim 2, wherein the wireless communication network deployment information is received through Over-The-Air (OTA) provisioning.

4. The method of claim 1, wherein the location of the multimode wireless device is determined using a Global Positioning System (GPS).

5. The method of claim 1, wherein the determination of whether the multimode wireless device is located at the location, or within the threshold distance of the location, in which the multimode wireless device can be serviced by the first wireless communication network occurs while a second communication module corresponding to a second wireless communication network among the plurality of communication networks is in an active state.

6. The method of claim 1, wherein the wireless communication network deployment information at least one of defines boundaries of one or more service coverage areas of the first wireless communication network, identifies one or more locations of one or more corresponding base stations of the first wireless communication network, defines boundaries of the one or more service coverage areas of the first wireless communication network with reference to one or more locations or identifying information of one or more corresponding base stations of a second wireless communication network of the plurality of wireless communication networks, and identifies locations of one or more base stations of the first wireless communication network with reference to one or more locations or identifying information of the one or more corresponding base stations of the other one of the second wireless communication network.

7. The method of claim 1, wherein the wireless communication network deployment information further includes wireless communication network deployment information for one or more wireless communication networks to which the multimode wireless device may roam from the first wireless communication network.

8. The method of claim 1, wherein the determining of the location of the multimode wireless device and the determining of whether the multimode wireless device is located at the location, or within the threshold distance of the location, in which the multimode wireless device can be serviced by the first wireless communication network occurs at least one of periodically and upon a detection of an occurrence of an event.

9. The method of claim 1, further comprising:
handing off the multimode wireless device from a second wireless communication network among the plurality of communication networks to the first wireless communication network after the first communication module is controlled to be in the active state; and
handing off the multimode wireless device from the first wireless communication network to the second wireless communication network before the first communication module is controlled to be in the inactive state.

10. A multimode wireless device for use in a communication system including a plurality of wireless communication networks, the multimode wireless device including:
a plurality of communication modules, each communication module for supporting communication with a respective one of the plurality of wireless communication networks;
a location determination module for determining a location of the multimode wireless device;
a memory for storing wireless communication network deployment information; and
a controller for determining whether the multimode wireless device is located at a location, or within a threshold distance of the location, in which the multimode wireless device can be serviced by a first wireless communication network among the plurality of wireless communication networks based on the location determined by the location determination module and the wireless communication network deployment information stored in the memory, for controlling a first communication module corresponding to the first wireless communication network to be in an active state when it is determined that the multimode wireless device is located at the location, or within the threshold distance of the location, in which the multimode wireless device can be serviced by the first wireless communication network, and for controlling the first communication module to be in an inactive state when it is determined that the multimode wireless device is not located at the location, or within the threshold distance of the location, in which the multimode wireless device can be serviced by the first wireless communication network.

11. The multimode wireless device of claim 10, wherein the controller controls to receive the wireless communication network deployment information from at least one of the plurality of wireless communication networks, and controls to store the wireless communication network deployment information in the memory.

12. The multimode wireless device of claim 11, wherein the wireless communication network deployment information is received through Over-The-Air (OTA) provisioning.

13. The multimode wireless device of claim 10, wherein the location determination module comprises a Global Positioning System (GPS) module.

14. The multimode wireless device of claim 10, wherein the controller determines whether the multimode wireless device is located at the location, or within the threshold distance of the location, in which the multimode wireless device can be serviced by the first wireless communication network while a second communication module corresponding to a second wireless communication network among the plurality of communication networks is in an active state.

15. The multimode wireless device of claim 10, wherein the wireless communication network deployment information at least one of defines boundaries of one or more service coverage areas of the first wireless communication network, identifies one or more locations of one or more corresponding base stations of the first wireless communication network, defines boundaries of the one or more service coverage areas of the first wireless communication network with reference to one or more locations or identifying information of one or more corresponding base stations of a second wireless communication network of the plurality of wireless communication networks, and identifies locations of one or more base stations of the first wireless communication network with reference to one or more locations or identifying information of the one or more corresponding base stations of the second wireless communication network.

16. The multimode wireless device of claim 15, wherein the wireless communication network deployment information includes wireless communication network deployment information for one or more wireless communication networks to which the multimode wireless device may roam from the first wireless communication network.

17. The multimode wireless device of claim 10, wherein the controller, controls the location determination module to determine the location of the multimode wireless device and determines whether the multimode wireless device is located at the location, or within the threshold distance of the location, in which the multimode wireless device can be serviced by the first wireless communication network, at least one of periodically and upon a detection of an occurrence of an event.

18. The multimode wireless device of claim 10, wherein the controller controls to hand off the multimode wireless device from a second wireless communication network among the plurality of communication networks to the first wireless communication network after the first communication module is controlled to be in the active state, and
wherein the controller controls to hand off the multimode wireless device from the first wireless communication network to the second wireless communication network before the first communication module is controlled to be in the inactive state.

19. A method for provisioning wireless communication network deployment information to a multimode wireless device in a communication system including a plurality of wireless communication networks, the method comprising:
determining whether to provision the multimode wireless device; and
when it is determined to provision the multimode wireless device, transmitting wireless communication network deployment information to the multimode wireless device,
wherein the wireless communication network deployment information at least one of defines boundaries of one or more service coverage areas of a first wireless communication network, identifies one or more locations of one or more corresponding base stations of the first wireless communication network, defines boundaries of the one or more service coverage areas of the first wireless communication network with reference to one or more locations or identifying information of one or more corresponding base stations of a second wireless communication network of the plurality of wireless communication networks, and identifies locations of one or more base stations of the first wireless communication network with reference to one or more locations or identifying information of the one or more corresponding base stations of the second wireless communication network.

20. The method of claim 19, wherein the wireless communication network deployment information is transmitted using Over-The-Air (OTA) provisioning.

21. The method of claim 19, wherein the wireless communication network deployment information includes wireless communication network deployment information for one or more wireless communication networks to which the multimode wireless device may roam from the first wireless communication network.
